(19) United States
(12) Patent Application Publication
(10) Pub. No.: US 2014/0299084 A1
(43) Pub. Date: Oct. 9, 2014

(54) UTILIZATION OF COOLANT HEATER EXHAUST TO PREHEAT ENGINE OIL

(71) Applicant: DEERE & COMPANY, Moline, IL (US)

(72) Inventors: Michael A. Adams, Cedar Falls, IA (US); Jason G. Knipper, Durango, IA (US)

(21) Appl. No.: 13/857,603

(22) Filed: Apr. 5, 2013

(51) Int. Cl. F01M 5/02; F02N 19/10

(52) U.S. Cl. CPC F01M 5/021; F02N 19/10
USPC 123/142.5 R

(57) ABSTRACT

A temperature control system and method that preheats both an engine coolant and an engine lubricant of a work vehicle to promote a successful start-up of the work vehicle, especially when operating the work vehicle in a cold environment.

### FIELD

The present disclosure relates to a temperature control system for a work vehicle. More particularly, the present disclosure relates to a temperature control system for heating and cooling fluids in a work vehicle, and to a method for using the same.

### BACKGROUND

Work vehicles may be operated in extremely cold environments. When the vehicle is turned off, fluids in the vehicle, including engine coolant and lubricating oil, may also become extremely cold. Before the vehicle is operated, the engine may be required to idle for a substantial period of time to re-warm the fluids. If the vehicle is operated when the fluids are too cold, the engine may not start properly and may be become damaged.

### SUMMARY

The present disclosure provides a temperature control system and method that preheats both an engine coolant and an engine lubricant of a work vehicle to promote a successful start-up of the work vehicle, especially when operating the work vehicle in a cold environment.

According to an embodiment of the present disclosure, a work vehicle is provided including a chassis, at least one traction device supporting the chassis, an engine operatively coupled to the at least one traction device to propel the chassis, an engine coolant, an engine lubricant, and an engine cooling system operable in a first mode to cool the engine coolant, and a second mode to heat the engine coolant and the engine lubricant, a heat exchange medium communicating with the engine coolant and the engine lubricant in the second mode.

According to another embodiment of the present disclosure, a work vehicle is provided including a chassis, at least one traction device supporting the chassis, an engine operatively coupled to the at least one traction device to propel the chassis, an engine lubrication system that circulates a lubricant around the engine, and an engine cooling system that circulates a coolant around the engine, the engine cooling system including a heater that heats the coolant by heat exchange with a heat exchange medium; and a passageway that directs the heat exchange medium from the heater toward the lubricant to heat the lubricant.

According to yet another embodiment of the present disclosure, a method is provided for operating a work vehicle. The work vehicle includes a chassis and an engine. The method includes the steps of heating an engine coolant by transferring heat from a heat exchange medium to the engine coolant, and heating an engine lubricant by directing the heat exchange medium toward the engine lubricant.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is an elevational view of an exemplary work vehicle of the present disclosure;

FIG. 2 is a schematic view of an engine, an engine lubrication system, and an engine cooling system for the work vehicle of FIG. 1, the engine lubrication system including an oil pan, and the engine cooling system including a cooler and a heater;

FIG. 3 is a perspective view inside the work vehicle of FIG. 1 showing the engine, the oil pan of the engine lubrication system, and the heater of the engine cooling system; and

FIG. 4 is a schematic view showing exhaust gas from the heater of the engine cooling system being used to heat the oil pan of the engine lubrication system inside the work vehicle of FIG. 1.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

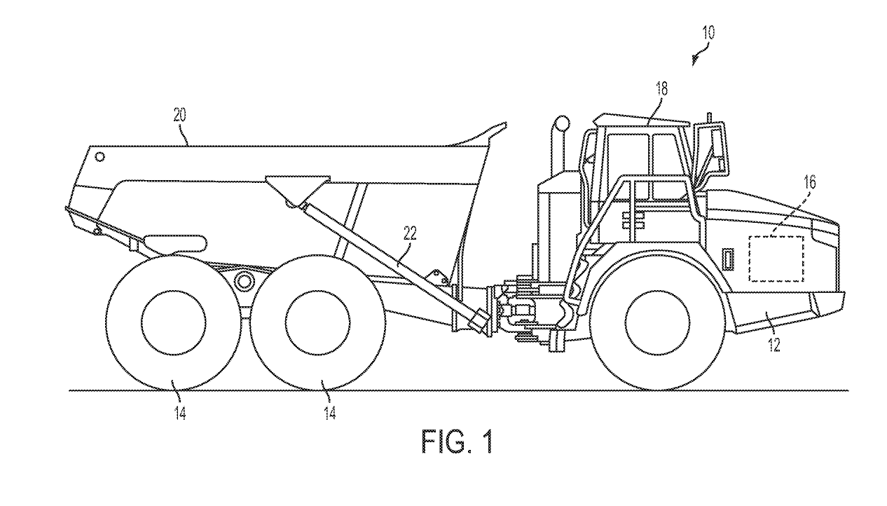

FIG. 1 provides a work vehicle 10 in the form of an articulated dump truck. Although vehicle 10 is illustrated and described herein as an articulated dump truck, vehicle 10 may also be in the form of a loader, a bulldozer, a motor grader, an excavator, or another construction, agricultural, or utility vehicle, for example.

Vehicle 10 includes chassis 12. One or more traction devices 14 illustratively a plurality of wheels, are provided to support chassis 12 on the ground. Although traction devices 14 are in the form of wheels in FIG. 1, it is also within the scope of the present disclosure that traction devices 14 may be in the form of tracks, for example. Vehicle 10 also includes an engine 16 (shown in phantom in FIG. 1), such as a diesel internal combustion engine, that communicates with fraction devices 14 to propel chassis 12 across the ground.

Vehicle 10 also includes an operator cab 18 supported by chassis 12 to house and protect the operator of vehicle 10. Operator cab 18 may include a seat and various controls or user inputs for operating vehicle 10.

Vehicle 10 may further include one or more work tools moveably coupled to chassis 12. In the illustrated embodiment of FIG. 1, vehicle 10 includes a bed 20 that is moveably coupled to chassis 12 to receive, transport, and dump dirt and other materials. Other suitable work tools include, for example, buckets, blades, forks, tillers, and mowers. One or more hydraulic actuators or cylinders 22 may be provided to move bed 20 relative to chassis 12.

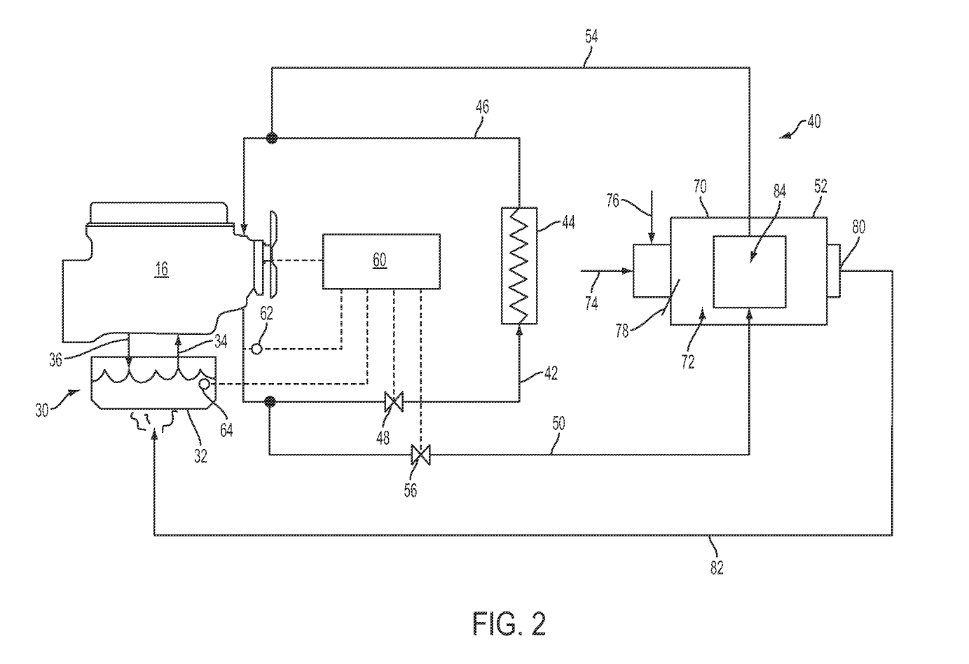

Referring next to FIG. 2, an engine lubrication system 30 and an engine cooling system 40 are provided for engine 16 of vehicle 10. A controller 60 having a suitably programmed microprocessor is also provided in FIG. 2 for operating engine 16, engine lubrication system 30, and/or engine cooling system 40.

The illustrative engine lubrication system 30 circulates a liquid lubricant (e.g., engine oil) around engine 16 to lubricate various moving parts (e.g., pistons, cylinders, bearings) of engine 16. In addition to lubricating engine 16, the engine oil may also clean engine 16, inhibit corrosion of engine 16, and improve sealing of engine 16, for example. In FIG. 2, engine lubrication system 30 illustratively includes an oil reservoir, sump, or pan 32 that holds the engine oil. Pan 32 may be located beneath engine 16, as shown in FIG. 2, or in another suitable location. Engine lubrication system 30 also includes a first conduit 34 that directs the engine oil from pan 32 to engine 16, and a second conduit 36 that returns the engine oil from engine 16 to pan 32.

The illustrative engine cooling system 40 circulates a liquid coolant (e.g., glycol, water) around engine 16 to control the temperature of engine 16. Engine cooling system 40 may also be referred to herein as a temperature control system. Engine cooling system 40 may be selectively operated in a warm-up mode or in an operational mode using controller 60. The warm-up mode and the operational mode are described further below.

In FIG. 2, a first temperature sensor 62 measures the temperature of the coolant and an optional second temperature sensor 64 measures the temperature of the engine oil. The location of each temperature sensor 62, 64, may vary. Additional temperature sensors may also be provided to measure the temperature of other components of vehicle 10. Controller 60 may receive temperature readings from one or more temperature sensors 62, 64, and may control engine cooling system 40 based on the temperature readings, as discussed further below.

In the operational mode, the liquid coolant may be circulated from engine 16, through a first conduit 42, through a cooler 44 (e.g., a radiator), through a second conduit 46, and back to engine 16. When the coolant travels across engine 16, the coolant absorbs heat from engine 16 to cool engine 16. When the coolant travels through cooler 44, the coolant releases heat into an ambient air stream or another suitable heat exchange medium traveling across cooler 44. The coolant may be sufficiently cooled in cooler 44 to absorb more heat from engine 16. In addition to cooling the coolant, cooler 44 may have various compartments to cool other fluids of vehicle 10, such as the lubricant that lubricates engine 16, the hydraulic fluid that operates cylinders 22 (FIG. 1), and/or brake fluid, for example.

Controller 60 may operate engine cooling system 40 in the operational mode when the coolant is at or above a predetermined temperature. The predetermined temperature may be about 75° C., 80° C., 85° C., 90° C., or more. The coolant may be at or above the predetermined temperature when engine 16 is running at full speed to operate vehicle 10. As long as the surrounding environment is relatively warm, the coolant may remain at or above the predetermined temperature even when vehicle 10 is turned off. Controller 60 may operate engine cooling system 40 in the operational mode by opening a valve 48 along first conduit 42, for example. Controller 60 may also communicate with a radiator fan (not shown) to control the cooling that takes place in cooler 44 during the operational mode.

In the warm-up mode, the liquid coolant may be circulated from engine 16, through a third conduit 50, through a coolant heater 52, through a fourth conduit 54, and back to engine 16. The coolant may be heated in coolant heater 52 and then returned to engine 16 to also heat engine 16.

Controller 60 may operate engine cooling system 40 in the warm-up mode when the coolant is below the predetermined temperature. The coolant may drop below the predetermined temperature when vehicle 10 is turned off, especially when the surrounding environment is relatively cold. In extremely cold environments, it is within the scope of the present disclosure that the temperature of the coolant may drop as low as about 0° C., −10° C., −20° C., −30° C., or −40° C., for example. The time required to heat the coolant to the predetermined temperature in the warm-up mode may be as short as about 10 minutes, 30 minutes, or 50 minutes, and as long as about 1 hour, 2 hours, or more, for example. Controller 60 may operate engine cooling system 40 in the warm-up mode by opening a valve 56 along third conduit 50, for example. Operating engine cooling system 40 in the warm-up mode, such as by opening valve 56, may involve terminating the other operational mode, such as by closing valve 48, and vice versa. Controller 60 may also communicate with coolant heater 52 to control the heating that takes place in coolant heater 52.

An exemplary coolant heater 52 for use in engine cooling system 40 is a diesel-fired coolant heater (DFCH). Such coolant heaters are described in U.S. Pat. No. 4,099,488 to Damon and U.S. Pat. No. 4,381,742 to Funk, the disclosures of which are expressly incorporated herein by reference in their entirety.

The illustrative coolant heater 52 of FIG. 2 includes a housing 70 that defines a combustion chamber 72. Coolant heater 52 includes a fuel inlet 74 into combustion chamber 72, an air inlet 76 into combustion chamber 72, an ignition source 78 (e.g., a spark plug), and a combustion outlet 80 from combustion chamber 72. Fuel inlet 74 may be coupled to a fuel source (not shown), such as a diesel fuel source, a gasoline fuel source, an ethyl ether fuel source, or another suitable fuel source. Air inlet 76 may receive ambient air from around vehicle 10. In use, ignition source 78 may supply electrical energy to coolant heater 52 to initiate an exothermic combustion reaction in combustion chamber 72 between the fuel from fuel inlet 74 and the air from air inlet 76. Together, the fuel from fuel inlet 74, the air from air inlet 76, and the electrical energy from ignition source 78 may serve as a thermal energy source. Gaseous combustion products (e.g., carbon dioxide, water vapor) may form inside combustion chamber 72 of coolant heater 52 to serve as a heat exchange medium. The gaseous combustion products may exit combustion chamber 72 through combustion outlet 80 and may be carried away through an exhaust passageway or conduit 82.

The illustrative coolant heater 52 of FIG. 2 also includes a coolant heating chamber 84 in thermal communication with the gaseous combustion products inside combustion chamber 72. Coolant heating chamber 84 communicates with third conduit 50 and fourth conduit 54 to direct the coolant through coolant heater 52. In this arrangement, third conduit 50 serves as a coolant inlet into coolant heating chamber 84, and fourth conduit 54 serves as a coolant outlet from coolant heating chamber 84. In operation, the gaseous combustion products in combustion chamber 72 exchange heat with the coolant in coolant heating chamber 84 to heat the coolant. Stated differently, thermal energy generated by the exothermic combustion reaction in combustion chamber 72 is transferred to the coolant in coolant heating chamber 84 to heat the coolant.

Like the above-described coolant, the temperature of the engine oil in pan 32 of engine lubrication system 30 may also drop below an acceptable operating temperature, especially when vehicle 10 is turned off in a cold environment. If the temperature of the engine oil is too low, the engine oil may not properly lubricate engine 16. As a result, the starter motor (not shown) and other components of engine 16 may experience high friction and high torque loads. Also, engine 16 may be unable to reach an acceptable oil pressure, which may damage turbochargers (not shown) and other components of engine 16, for example.

The gaseous combustion products that were used to heat the coolant in coolant heater 52 may still be relatively hot, with temperatures ranging from about 200° C. to about 250° C. or more. Before discharging the hot combustion products from vehicle 10 and into the surrounding atmosphere, the hot combustion products may be used as a heating source for a second time to heat other fluids or components of vehicle 10 during the warm-up mode. Using the hot combustion products as a heating source for a second time takes advantage of an otherwise-wasted energy stream. Also, using the hot combustion products as a heating source improves the efficiency of engine cooling system 40 without significantly increasing the cost of manufacturing or operating engine cooling system 40.

According to an exemplary embodiment of the present disclosure, the hot combustion products from exhaust conduit 82 of coolant heater 52 are used to preheat the engine oil in pan 32 of engine lubrication system 30 during the warm-up mode. Preheating the engine oil in pan 32 may protect engine 16 and ensure a successful start-up of engine 16 by preventing oil starvation and by encouraging pressure development of the engine oil within an acceptable period of time, especially when operating vehicle 10 in an extremely cold environment. For example, preheating the engine oil in pan 32 may ensure adequate oiling of turbocharger bearings (not shown). In this embodiment, the hot combustion products may first heat the coolant (via coolant heating chamber 84) and then heat the engine oil (via exhaust conduit 82) during the warm-up mode. The time required to adequately heat the coolant and the engine oil in the warm-up mode may be as short as about 10 minutes, 30 minutes, or 50 minutes, and as long as about 1 hour, 2 hours, or more, for example.

By using hot combustion products as the heating source for the engine oil, vehicle 10 may maintain separation between the liquid engine oil and coolant streams. In other words, vehicle 10 may avoid any heightened risk of cross-contamination or leakage between the liquid engine oil and coolant streams. Thus, the integrity of engine lubrication system 30 and engine cooling system 40 may be maintained without requiring additional seals or controls, for example.

As discussed above, controller 60 may operate engine cooling system 40 in the warm-up mode based on temperature readings from one or more temperature sensors 62, 64. In one embodiment, controller 60 may operate engine cooling system 40 in the warm-up mode based on the temperature of the coolant from temperature sensor 62. In this embodiment, controller 60 may assume that the engine oil has also reached an acceptable temperature when the coolant reaches its predetermined temperature. In another embodiment, controller 60 may operate engine cooling system 40 in the warm-up mode based on the temperature of the coolant from temperature sensor 62 and the temperature of the engine oil from temperature sensor 64. In this embodiment, controller 60 may ensure that both the coolant and the engine oil have reached acceptable temperatures before operating engine 16.

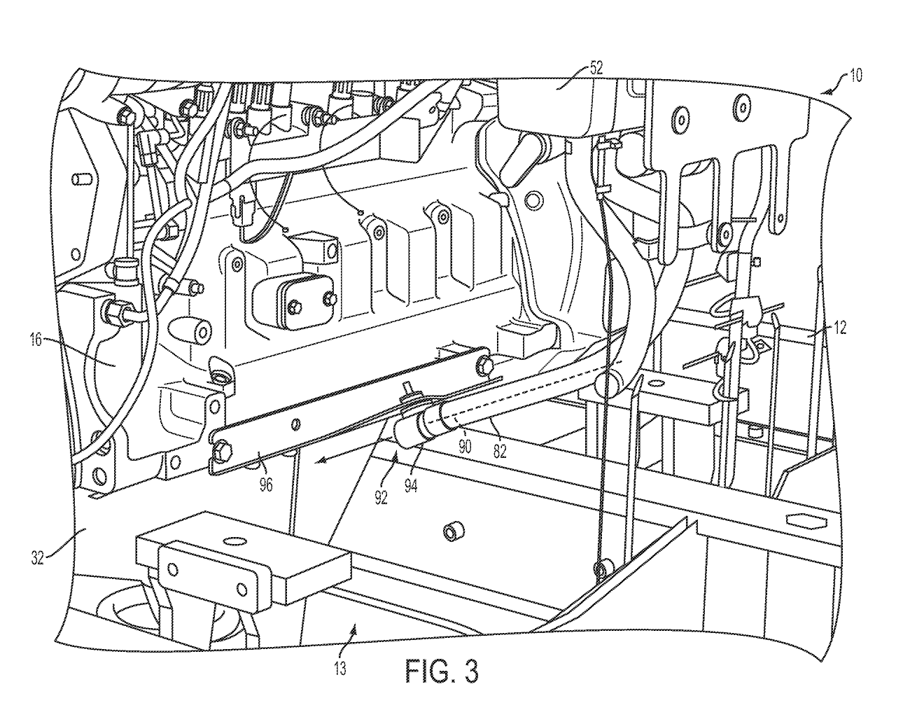

Exhaust conduit 82 of an exemplary coolant heater 52 is shown in more detail in FIG. 3. Exhaust conduit 82 includes a delivery axis 90 and an open delivery end 92. During operation of coolant heater 52, hot combustion products travel along the delivery axis 90 and exit through the open delivery end 92 of exhaust conduit 82. As shown in FIG. 3, exhaust conduit 82 is directed (i.e., aimed, pointed) toward oil pan 32 of engine lubrication system 30. More specifically, delivery axis 90 of exhaust conduit 82 is directed toward oil pan 32 of engine lubrication system 30, such that delivery axis 90 intersects oil pan 32. In this arrangement, the hot combustion products traveling along the delivery axis 90 exit through the open delivery end 92 of exhaust conduit 82 and then collide with oil pan 32. These hot combustion products may heat oil pan 32 by convection, and in turn, the warmed oil pan 32 may heat the engine oil contained therein.

Delivery end 92 of exhaust conduit 82 may be secured in place relative to oil pan 32 to ensure that exhaust conduit 82 remains directed toward oil pan 32 during operation of vehicle 10. In the illustrated embodiment of FIG. 3, a holder 94 is provided around delivery end 92 of exhaust conduit 82, and holder 94 is screwed into or otherwise coupled to a support structure 96 (e.g., a bracket) on engine 16. In this embodiment, even when vehicle 10 travels over rough terrain, the fixed coupling between holder 94 and support structure 96 maintains a fixed relationship between delivery end 92 of exhaust conduit 82 and oil pan 32. Thus, delivery end 92 of exhaust conduit 82 is prevented from shifting away from oil pan 32.

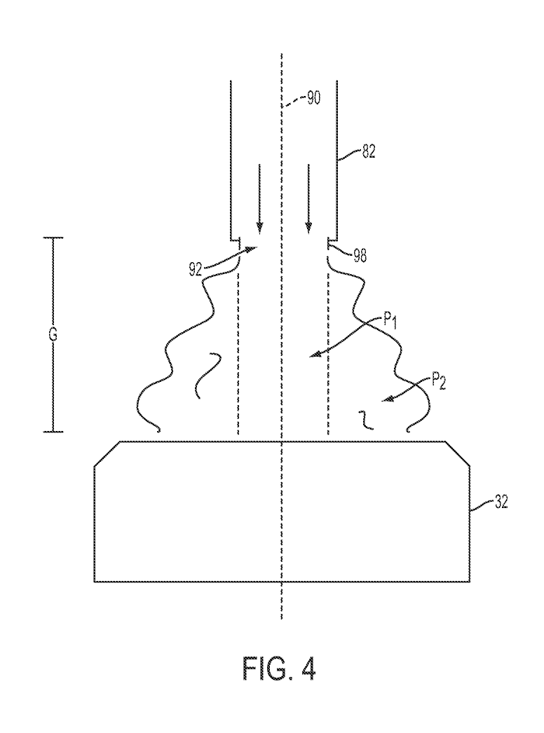

As shown in FIG. 4, delivery end 92 of exhaust conduit 82 may be spaced apart from oil pan 32 to define a gap G therebetween. When traveling through the gap G from exhaust conduit 82 to oil pan 32, a first portion P₁ of the hot combustion products may remain within the periphery 98 of delivery end 92. Another portion P₂ of the hot combustion products may spread radially outwardly beyond the periphery 98 of delivery end 92 and across the surface of oil pan 32. The gap G may be configured to maximize contact between the hot combustion products and oil pan 32. For example, the gap G may be configured to maximize the surface area of oil pan 32 that is exposed to the first and second portions P₁, P₂, of the hot combustion products, while minimizing any unnecessary contact between other components of vehicle 10 and the hot combustion products. The size of gap G may vary. For example, the gap G may be as small as about 2 in., 4 in., or 6 in., and as large as about 8 in., 10 in., 12 in., or more. It is also within the scope of the present disclosure that an enclosure (not shown) may be provided between exhaust conduit 82 and oil pan 32 to direct the hot combustion products from exhaust conduit 82, through the enclosure, and toward oil pan 32.

After contacting and heating oil pan 32, the hot combustion products may be discharged from vehicle 10 and into the surrounding atmosphere. In the illustrated embodiment of FIG. 3, the hot combustion products may escape through an opening 13 in the underside of chassis 12. The size and location of opening 13 may vary.

When the coolant and/or the engine oil have reached acceptable operating temperatures, controller 60 may transition engine cooling system 40 from the warm-up mode to the operational mode. Also, controller 60 may communicate with engine 16 to allow engine 16 to increase from an idle speed to a full operational speed. As discussed above, preheating the coolant and the engine oil during the warm-up mode may protect engine 16 and ensure a successful start-up of engine 16.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A work vehicle including:
a chassis;
at least one traction device supporting the chassis;
an engine operatively coupled to the at least one traction device to propel the chassis;
an engine coolant;
an engine lubricant; and
an engine cooling system operable in:
a first mode to cool the engine coolant; and
a second mode to heat the engine coolant and the engine lubricant, a heat exchange medium communicating with the engine coolant and the engine lubricant in the second mode.

2. The work vehicle of claim 1, wherein, in the second mode, the heat exchange medium heats the engine coolant in a heater.

3. The work vehicle of claim 2, wherein the heater comprises a combustion heater.

4. The work vehicle of claim 2, wherein the heater includes an exhaust conduit that directs the heat exchange medium from the heater toward the engine lubricant.

5. The work vehicle of claim 4, wherein the engine lubricant is stored in a pan, and wherein the exhaust conduit includes a delivery axis that intersects the pan.

6. The work vehicle of claim 5, wherein the exhaust conduit is fixedly coupled relative to the pan.

7. The work vehicle of claim 1, wherein the heat exchange medium comprises gaseous combustion products.

8. The work vehicle of claim 1, wherein, in the first mode, the engine coolant is cooled in a radiator.

9. The work vehicle of claim 1, further including a controller that controls operation of the engine cooling system in the first mode and the second mode.

10. The work vehicle of claim 1, wherein the engine cooling system operates in the first mode when the engine coolant is at or above a predetermined temperature.

11. The work vehicle of claim 10, wherein the predetermined temperature is at least about 5° C.

12. The work vehicle of claim 10, wherein the engine cooling system operates in the second mode when the engine coolant is below the predetermined temperature.

13. A work vehicle including:
a chassis;
at least one traction device supporting the chassis;
an engine operatively coupled to the at least one traction device to propel the chassis;
an engine lubrication system that circulates a lubricant around the engine; and
an engine cooling system that circulates a coolant around the engine, the engine cooling system including:
a heater that heats the coolant by heat exchange with a heat exchange medium; and
a passageway that directs the heat exchange medium from the heater toward the lubricant to heat the lubricant.

14. The work vehicle of claim 13, wherein the engine cooling system further includes a cooler that cools the coolant.

15. The work vehicle of claim 14, further including a controller that directs the coolant through the heater in a first mode and through the cooler in a second mode.

16. The work vehicle of claim 15, further including at least one temperature sensor in communication with the controller, wherein the controller operates the engine cooling system in the first mode or the second mode based on a temperature input from the at least one temperature sensor.

17. A method of operating a work vehicle, the work vehicle including a chassis and an engine, the method including the steps of:
heating an engine coolant by transferring heat from a heat exchange medium to the engine coolant; and
heating an engine lubricant by directing the heat exchange medium toward the engine lubricant.

18. The method of claim 17, wherein the step of heating the engine lubricant includes directing the heat exchange medium toward a pan that stores the engine lubricant.

19. The method of claim 18, wherein the heat exchange medium comprises gaseous combustion products, and wherein the step of heating the engine lubricant includes directing an exhaust conduit toward the pan to direct the gaseous combustion products toward the pan.

20. The method of claim 17, further including the step of discharging the heat exchange medium from the work vehicle after the heating steps.

21. The method of claim 17, wherein the heat exchange medium heats the engine coolant before heating the engine lubricant.
